(19) United States
(12) Patent Application Publication
(10) Pub. No.: US 2008/0011737 A1
(43) Pub. Date: Jan. 17, 2008

(54) Hot plate and process for producing the same

(75) Inventors: Tetsuo Fukuoka, Koshi-Shi (JP); Takahiro Kitano, Koshi-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo-to (JP)

(21) Appl. No.: 11/757,641

(22) Filed: Jun. 4, 2007

(30) Foreign Application Priority Data
Jun. 7, 2006 (JP) 2006-158898

(51) Int. Cl. H05B 3/68

(52) U.S. Cl. 219/444.1; 29/611

(57) ABSTRACT

A hot plate for heating a substrate placed on the hot plate. The hot plate comprises a silicon base having pin insertion holes through which support pins for supporting a substrate from below and elevating the substrate above the hot plate pass; a heater composed of a resistor made of a metal film deposited on the back surface of the silicon base; and a temperature sensor, composed of a resistor made of a metal film deposited on the back or front surface of the silicon base. The front surface of the silicon base has gap-making protrusions for making a gap between the hot plate and a substrate placed on the gap-making protrusions.

### CROSS-REFERENCE TO RELATED APPLICATION

This application claims priority to Japanese Patent Application No. 2006-158898 filed on Jun. 7, 2006, and the whole description in Application No. 2006-158898 is incorporated herein by reference.

### BACKGROUND OF THE INVENTION

1. Field of the Invention

The present invention relates to a hot plate for uniformly heating a substrate, such as a semiconductor wafer, to be treated, and to a process for producing it.

2. Background Art

The process of semiconductor device production includes the steps of thermally treating a wafer on which a semiconductor device will be made. For example, in heat treatment for drying that is carried out after resist coating, in post exposure baking, and in CVD for depositing a predetermined thin film on a semiconductor wafer surface, a table on which a semiconductor wafer is placed is provided with a heater, and, with this heater, the semiconductor wafer on the table is heated to a predetermined temperature.

For example, Japanese Laid-Open Patent Publication No. 189613/1997 (see FIG. 8) discloses a hot plate for use in a baking system for thermally treating a silicon wafer, on which a semiconductor device will be made, after coating the upper surface of the silicon wafer with a photoresist. The hot plate, which serves as a table on which a silicon wafer, a substrate to be treated, is placed, comprises in it a heater for heating the silicon wafer.

In the case where such a hot plate, i.e., a table provided with a heater, is used to heat a semiconductor wafer, it has to heat the wafer so that the temperature distribution of the wafer becomes as uniform as possible in order to improve yields.

A conventional hot plate comprises a heater, a resistor, printed by a silk screen process on, or bonded to, an aluminum plate with a thickness of about 10 mm or a base plate, such as a ceramic plate, with a thickness of about 3 mm. It is therefore inevitable that the heater formed on the base plate be non-uniform in width or thickness, which often makes the heating value distribution of the hot plate non-uniform and affects the uniformity in semiconductor wafer temperature.

Further, in the case where temperature sensors are provided on the base plate, they have so far been embedded in or bonded to the base plate, so that they are often not precise in position or non-uniform in size, which affects the accuracy in sensing the semiconductor wafer temperature.

### SUMMARY OF THE INVENTION

Under the above-described circumstances, the present invention was accomplished. An object of the present invention is to provide a hot plate comprising a heater improved in uniformity in heating value, capable of more uniformly heating a substrate to be treated, and a process for producing the hot plate.

In order to fulfill the above object, the present invention provides a hot plate for heating a substrate placed on the hot plate, comprising a silicon base having pin insertion holes through which support pins for supporting a substrate from below and elevating the substrate above the hot plate pass; a heater composed of a resistor made of a metal film deposited on the back surface of the silicon base; a temperature sensor composed of a resistor made of a metal film deposited on the back or front surface of the silicon base; and gap-making protrusions for making a gap between the hot plate and the substrate placed on the gap-making protrusions, made on the front surface of the silicon base.

In the hot plate of the present invention, it is preferred that the heater be made of platinum (Pt) film and that the temperature sensor be made of platinum (Pt) film as well.

In the hot plate of the invention, gap pins made of silicon or protrusions made of a synthetic resin material, formed on the front surface of the silicon base, may be used as the gap-making protrusions.

In the hot plate according to the present invention, a vacuum holding groove and a vacuum holding hole that are useful for vacuum holding a substrate for subjecting the substrate to heat treatment may be made in the front surface of the silicon base.

A process for producing a hot plate according to the present invention is a process for producing the above-described hot plate for heating a substrate placed on the hot plate. The process for producing a hot plate comprises the steps of making a heater composed of a resistor by depositing a metal film on the back surface of a silicon base by sputtering, making a temperature sensor composed of resistors by depositing a metal film on the back or front surface of the silicon base by sputtering, making, in the silicon base, pin insertion holes through which support pins for supporting a substrate from below and elevating the substrate above the hot plate pass, and, making, on the front surface of the silicon base, gap-making protrusions for making a gap between the hot plate and the substrate placed on the gap-making protrusions.

In the process for producing a hot plate according to the present invention, it is preferable to use platinum (Pt) as a material for the heater and also for the temperature sensor.

In the process for producing a hot plate according to the invention, it is preferable to make, as the gap-making protrusions, gap pins made of silicon by etching the front surface of the silicon base, or make protrusions made of a synthetic resin material on the front surface of the silicon base as the gap-making protrusions by using a synthetic resin material.

Preferably, the process for producing a hot plate according to the present invention further comprises the step of making, in the front surface of the silicon base by a photolithographic technique and etching, a vacuum holding groove and a vacuum holding hole that are useful for vacuum holding a substrate for subjecting the substrate to heat treatment.

According to the present invention, since the heater is made directly on the back surface of the silicon base of the hot plate by MEMS (Micro Electro Mechanical Systems) or a semiconductor production technique, it is more uniform in width and thickness and has higher accuracy as compared with conventional heaters made by printing or bonding. Such a heater of the invention can make the heating value of the hot plate uniform, so that the hot plate can more uniformly heat a substrate, such as a semiconductor wafer, placed on the hot plate.

Further, in the present invention, since the temperature sensor is also made directly on the back or front surface of the silicon base of the hot plate, its accuracy is high. Therefore, it becomes possible to control precisely the temperature of the hot plate by providing a plurality of the temperature sensors.

Furthermore, in the present invention, gap pins are made as the gap-making protrusions on the front surface of the silicon base of the hot plate, so that a gap can be accurately made between the hot plate and a substrate placed on the gap-making protrusions.

Furthermore, in the present invention, since a vacuum holding hole and a vacuum holding groove are made in the front surface of the silicon base of the hot plate, a substrate can be vacuum held and fixed forcedly to the hot plate even if the substrate is curved. The substrate can thus be evenly held on the hot plate. Moreover, since a photolithographic technique and etching are employed to make the a vacuum holding groove and the vacuum holding hole, the groove and the hole have the function of accurately chucking a substrate to vacuum hold it evenly.

### BRIEF DESCRIPTION OF THE DRAWINGS

FIG. 1 is a view showing the back surface of a hot plate according to the first embodiment of the present invention.

FIG. 2 is a view showing the front surface of a hot plate according to the first embodiment of the present invention.

FIG. 3 is a view showing the first half of the procedure for making a heater of the hot plate according to the first embodiment of the present invention.

FIG. 4 is a view showing the latter half of the procedure for making the heater of the hot plate according to the first embodiment of the present invention.

FIG. 5 is a view showing the first half of the procedure for making temperature sensors of the hot plate according to the first embodiment of the present invention.

FIG. 6 is a view showing the latter half of the procedure for making the temperature sensors of the hot plate according to the first embodiment of the present invention.

FIG. 7 is a view showing the first half of the procedure for making pin insertion holes and gap-making protrusions of the hot plate according to the first embodiment of the present invention.

FIG. 8 is a view showing the latter half of the procedure for making the pin insertion holes and the gap-making protrusions of the hot plate according to the first embodiment of the present invention.

FIG. 9 is a view showing the front surface of a hot plate according to the second embodiment of the present invention.

FIG. 10 is a view showing the first half of the procedure for producing the hot plate according to the second embodiment of the present invention.

FIG. 11 is a view showing the latter half of the procedure for producing the hot plate according to the second embodiment of the present invention.

FIG. 12 is a view showing the front surface of a hot plate according to the third embodiment of the present invention.

FIG. 13 is a view showing the first half of the procedure for producing the hot plate according to the third embodiment of the present invention.

FIG. 14 is a view showing the latter half of the procedure for producing the hot plate according to the third embodiment of the present invention.

FIG. 15 is a diagrammatical plane view showing a resist coating/development system using heat treatment equipment having a hot plate of the present invention.

FIG. 16 is a diagrammatical front view of the resist coating/development system shown in FIG. 15.

FIG. 17 is a diagrammatical rear view of the resist coating/development system shown in FIG. 15.

FIG. 18 is a view showing the structure of the heat treatment equipment using a hot plate of the present invention, shown in FIG. 15.

### DESCRIPTION OF THE PREFERRED EMBODIMENTS

With reference to the accompanying drawings, the best mode of the present invention will be described hereinafter.

### First Embodiment

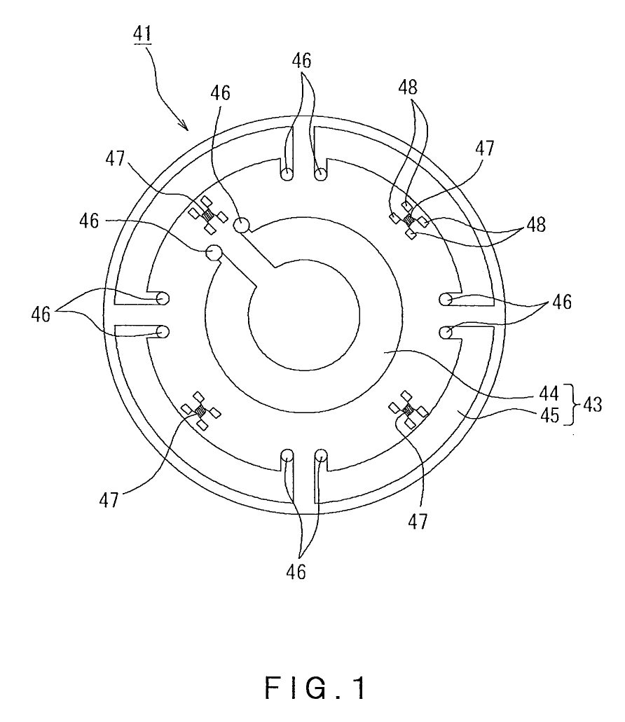

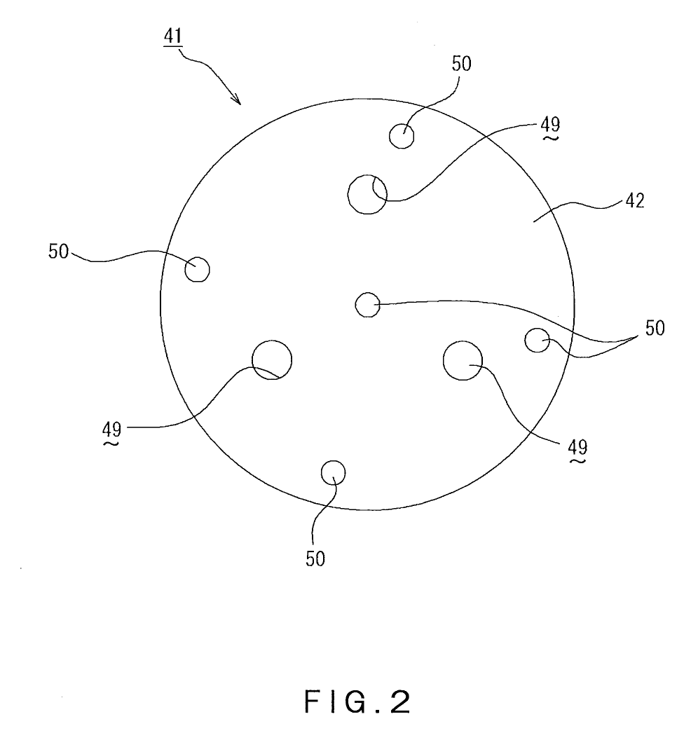

FIG. 1 is a view showing the back surface of a hot plate 41 useful for heat treatment according to the first embodiment of the present invention, and FIG. 2 is a view showing the front surface of the hot plate 41. The hot plate 41 shown in these figures is intended for a wafer with a thickness of 750 μm and a diameter of 300 mm, for example, and 0.5 to 3-mm thick wafers with a diameter of 340 mm can be placed on it.

The base plate of this hot plate 41 is a disc-shaped silicon base 42 with a thickness of 0.5 to 3 mm and a diameter of 340 mm, for example, and, on its back surface, a linear or belt-like heater 43 is provided by depositing, by sputtering, a film of platinum (Pt), a resistor, in a predetermined pattern such as a winding pattern, an arc, or a pattern with one stroke, in FIG. 1. In this Specification, the belt-like heater means not only a flat heating element but also a linear heating element that has been zigzagged, for example, to form a plane as a whole.

In this embodiment, a first annular heater 44 is provided in the center, and a second annular heater 45, around the first annular heater 44. The second annular heater 45 is divided into four sectors. On both ends of the first annular heater 44 and on both ends of each sector of the second annular heater 45 are provided electrode terminals 46 made of Ni/Cr films deposited by sputtering.

On the back surface of the silicon base 42, small temperature sensors 47 are formed by depositing by sputtering platinum (Pt) film, a resistor, at four points that correspond to the four apexes of a quadrate, and on both ends of each temperature sensor 47, a pair of electrode terminals 48 are formed by depositing Ni/Cr film by sputtering. In this Specification, the small temperature sensor means not only a temperature sensor made of a flat resistor but also one made of a linear resistor that has been zigzagged to form a plane as a whole.

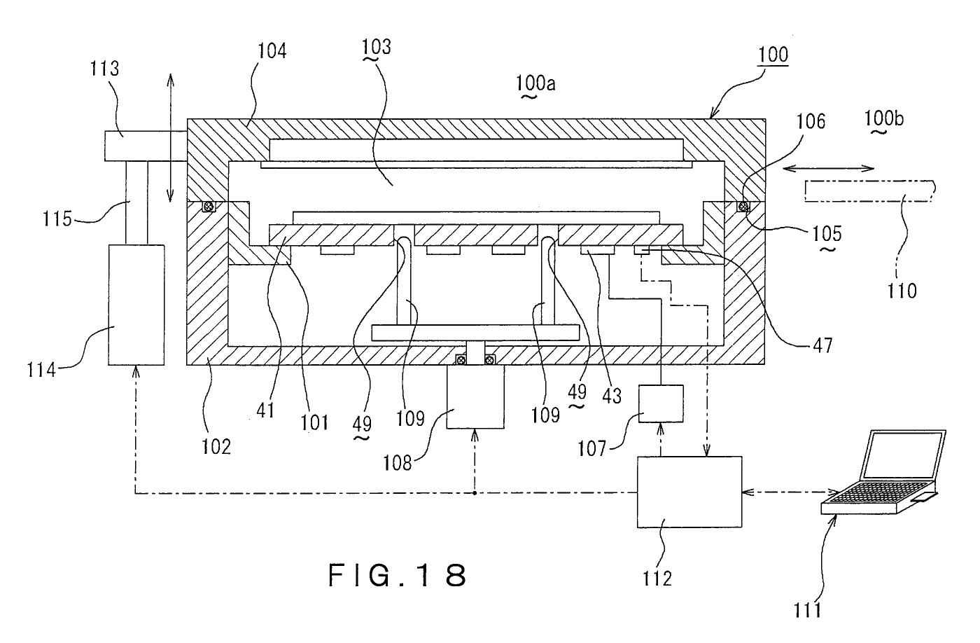

In the front surface of the silicon base 42, three pin insertion holes 49 through which three support pins 109 (see FIG. 18) for supporting a semiconductor wafer W from below and elevating it above the hot plate 41 pass are made by dry etching at three points that correspond to the three apexes of an equilateral triangle, as shown in FIG. 2. Further, five gap pins 50, serving as gap-making protrusions for making a narrow gap between the hot plate 41 and a semiconductor wafer W placed on it, are photolithographically made on the front surface of the silicon base 42 at four points corresponding to the four apexes of a square and also at one point corresponding to the center of the square.

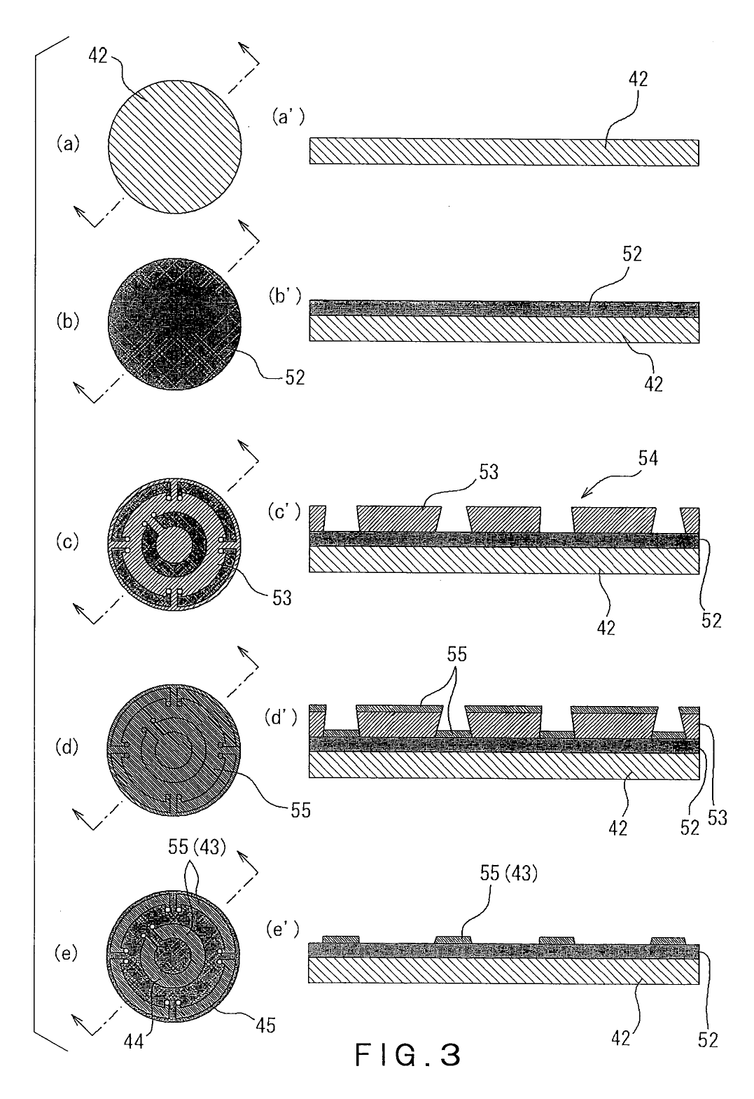

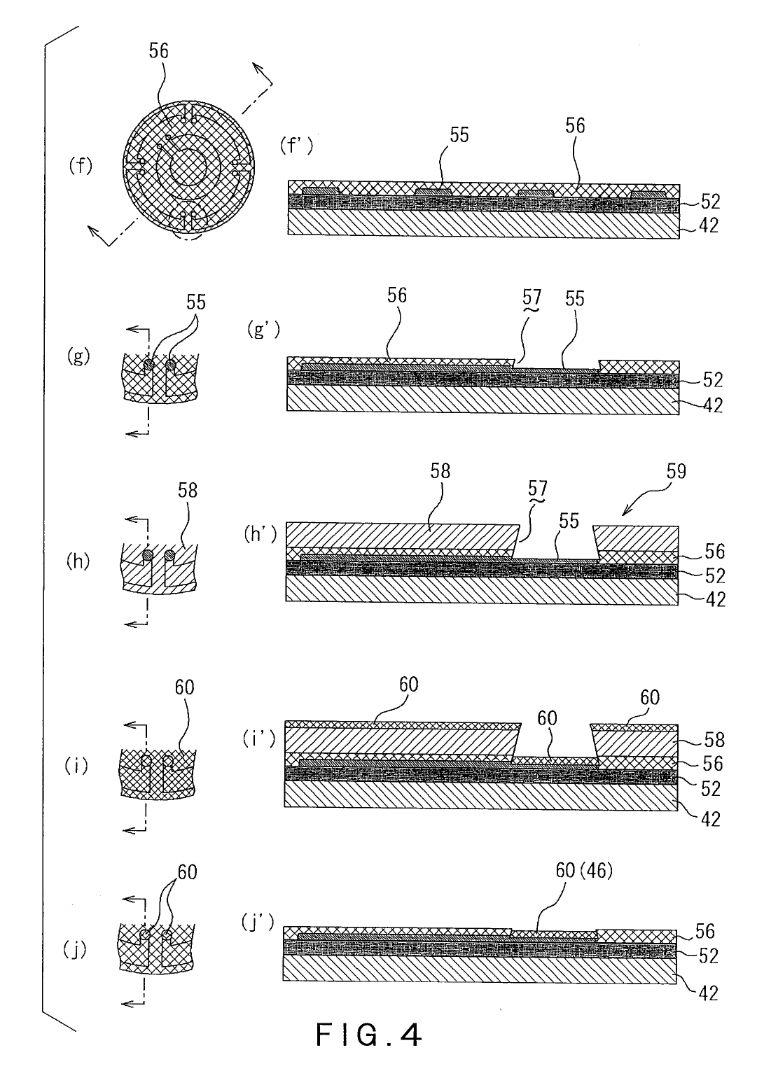

A process for producing the above-described hot plate 41 will be described with reference to FIGS. 3 to 8.

[Procedure for Making Heater 43 (FIGS. 3 and 4)]

The procedure for making the heater 43 on the back surface of the silicon base 42 is shown in FIGS. 3(a), 3(a′) to 3(e), 3(e′) and FIGS. 4(f), 4(f′) to 4(j), (j′). In FIGS. 3 and 4, views (a)-(j) on the left-hand side show the back surface of the hot plate 41, and views (a′)-(j′) on the right-hand side, the section of the hot plate 41 taken along the line extending in the direction of the diameter of the hot plate 41, indicated by the arrows. FIGS. 4(g), 4(g′) to 4(j), 4(j′) show a part of the back surface of the hot plate 41 and the enlarged section of this part of the hot plate 41 taken along the line crossing the terminal, indicated by the arrows.

First, the procedure for forming a film of Pt, a resistor, serving as the above-described heater 43, will be described.

As shown in FIG. 3, a silicon base 42 with a diameter of 340 mm and a thickness of 3 mm is prepared (FIGS. 3(a), 3(a′)) as the base of a hot plate, and SiO₂ film 52 is formed on the whole back surface of the silicon base 42 (FIGS. 3(b), 3(b′)). On this SiO₂ film 52, a resist pattern 54 corresponding to a predetermined heater pattern is photolithographically formed via the steps of photoresist 53 coating, exposure, development, and photoresist stripping (FIGS. 3(c), 3(c′)).

Next, Pt film 55 is deposited on the whole surface of the SiO₂ film 52 by sputtering, with the resist pattern 54 left as it is (FIGS. 3(d), 3(d′)). Thereafter, the resist pattern 54 is removed together with the Pt film 55 formed on it (lift-off) (FIGS. 3(e), 3(e′)). By this so-called lift-off method, the belt-like Pt film 55 remains as a resistor (heater 43) only in a predetermined heater pattern area. In this step, a first annular heater 44 is formed in the center, and a second annular heater 45 divided into four sectors, around the first annular heater 44.

Next, the procedure for making electrode terminals 46 for the above-described heater 43 will be described.

As shown in FIG. 4, a polyimide film 56, an insulating polyimide resin film, is formed on the whole surface of the above-described silicon base 42 having the Pt film 55 (FIGS. 4(f), 4(f′)), and this insulating film 56 is patterned so that it has openings 57, each opening in a shape corresponding to the shape of the terminal for the heater 43, thereby exposing the Pt film 55 (FIGS. 4(g), 4(g′)).

A photoresist pattern 59 corresponding to a predetermined terminal pattern is then photolithographically formed on the polyimide film 56 via the steps of photoresist 58 coating, exposure, development, and photoresist stripping, with the openings 57 left as they are (FIGS. 4(h), 4(h′)).

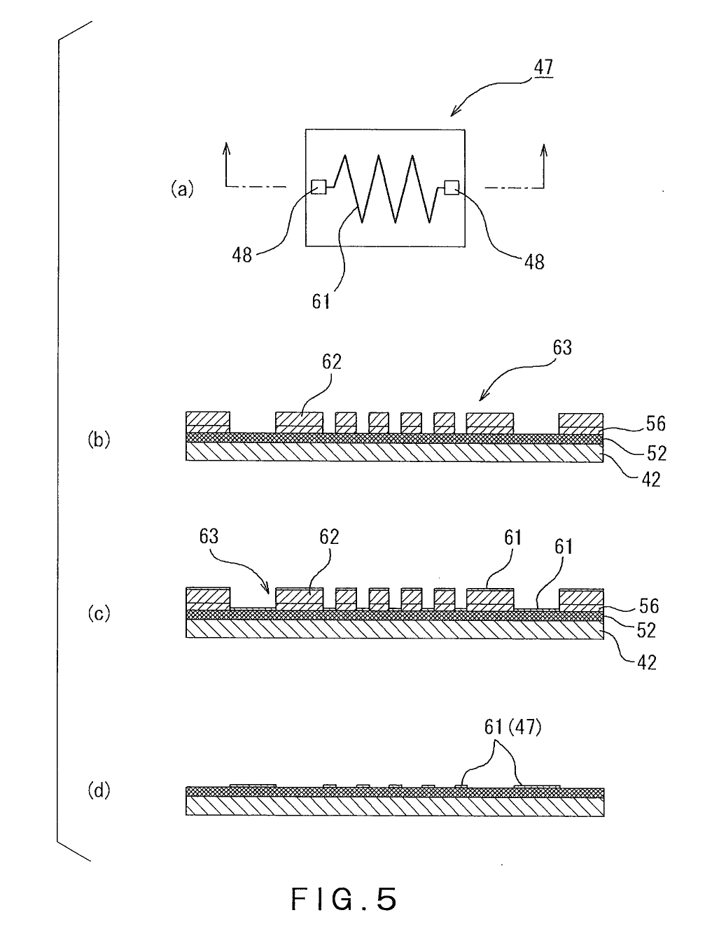

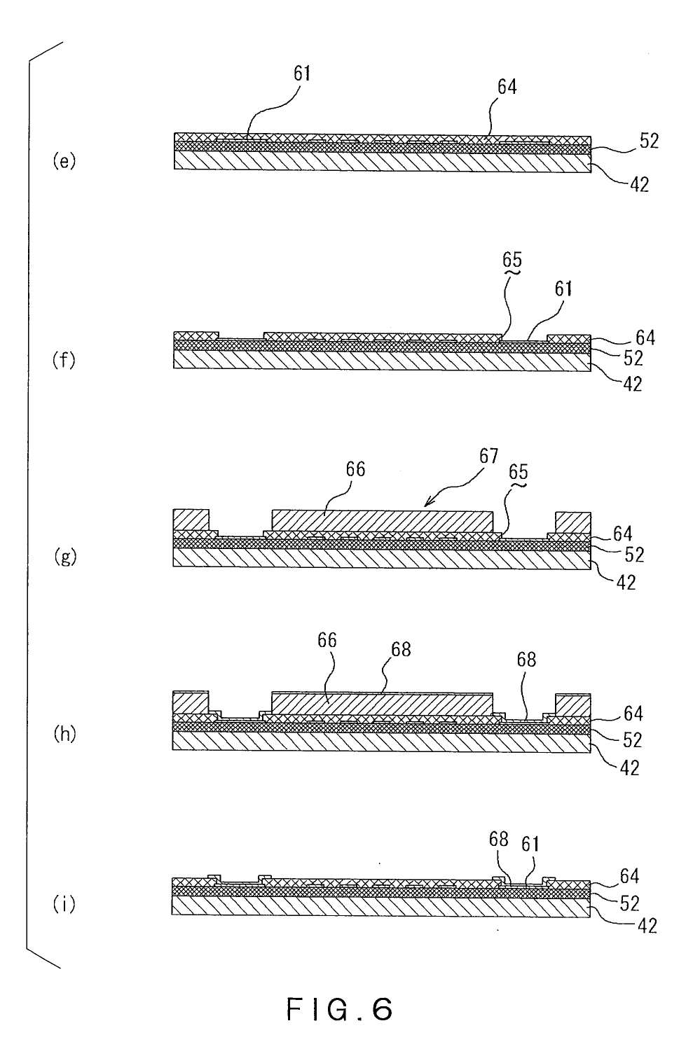

Thereafter, Ni/Cr film 60 (e.g., 0.15 μm/0.01 μm) is deposited by sputtering on the whole surface of the polyimide film 56, with the resist pattern 59 left as it is (FIGS. 4(i), (i′)). The resist pattern 59 is then removed together with the Ni/Cr film 60 formed on it (lift-off) (FIG. 4(j), 4(j′)). Thus, an electrode terminal 46 having on its surface the Ni/Cr film 60 is formed on each end of the first annular heater 44 and also on each end of each sector of the second annular heater 45.

[Procedure for Making Temperature Sensors 47 (FIGS. 5 and 6)]

The procedure for making the temperature sensors 47 on the back surface of the silicon base 42 is shown in FIGS. 5(b) to 5(d) and FIGS. 6(e) to 6(i). FIG. 5(a) schematically shows the temperature sensor 47. This temperature sensor 47 is composed of Pt film 61, a resistor, in the shape of a zigzag line, and electrode terminals 48 on both ends of the Pt film 61. In FIGS. 5 and 6, views (b) to (i) show the section of the temperature sensor 47 shown in FIG. 5(a), taken along the line crossing the electrode terminals 48 on both ends of the temperature sensor 47, indicated by the arrows. The reason why the temperature sensors 47 and the heater 43 are not made in one step although the same material, Pt film, is used for them is that the thickness of the Pt film serving as the heater 43, which is 2.0 μm, is different from the thickness of the Pt film serving as the temperature sensor 47, which is 0.3 μm.

As shown in FIG. 5(b), a resist pattern 63 corresponding to a predetermined sensor pattern is photolithographically formed on the back surface of the silicon base 42 (on the polyimide film 56 in FIG. 5(b)) having the heater 43 and the electrode terminals 46 via the steps of photoresist 62 coating, exposure, development, and photoresist stripping (FIG. 5(b)). Those portions of the polyimide film 56 that are not covered with this resist pattern 63 are removed. FIG. 5(b) shows the state after these portions of the polyimide film 56 have been removed.

Thereafter, Pt film 61 is deposited on the whole surface of the polyimide film 56 by sputtering, with the resist pattern 63 left on the polyimide film 56 (FIG. 5(c)). The resist pattern 63 is then removed along with the Pt film 61 formed on it (lift-off) (FIG. 5(d)). At this time, the polyimide film 56 is removed together with the resist pattern 63, but the polyimide film 56 existing not on the temperature sensor 47 is not removed and left as it is. Thus, the Pt film 61 remains as a resistor (temperature sensor 47) only on the belt-like area of the predetermined sensor pattern (zigzag line area in this case). The polyimide film 56 may not be removed and left as it is.

Next, the procedure for making the electrode terminals 48 for the above-described temperature sensors 47 will be described.

As shown in FIG. 6, a polyimide film 64, an insulating polyimide resin film, is formed on the whole surface of the silicon base 42 having the Pt film 61 (FIG. 6(e)). If the polyimide film 56 is not removed, the polyimide film 64 is formed on the polyimide film 56. The polyimide film 64 (or the polyimide film 56 and the polyimide film 64) is patterned so that it has openings 65, each opening in a shape corresponding to the shape of the electrode terminal for the temperature sensor 47, thereby exposing the Pt film 61 (FIG. 6(f)).

A resist pattern 67 corresponding to a predetermined terminal pattern is then photolithographically formed on the polyimide film 64 with the openings 65 left as they are, via the steps of photoresist 66 coating, exposure, development, and photoresist stripping (FIG. 6(g)).

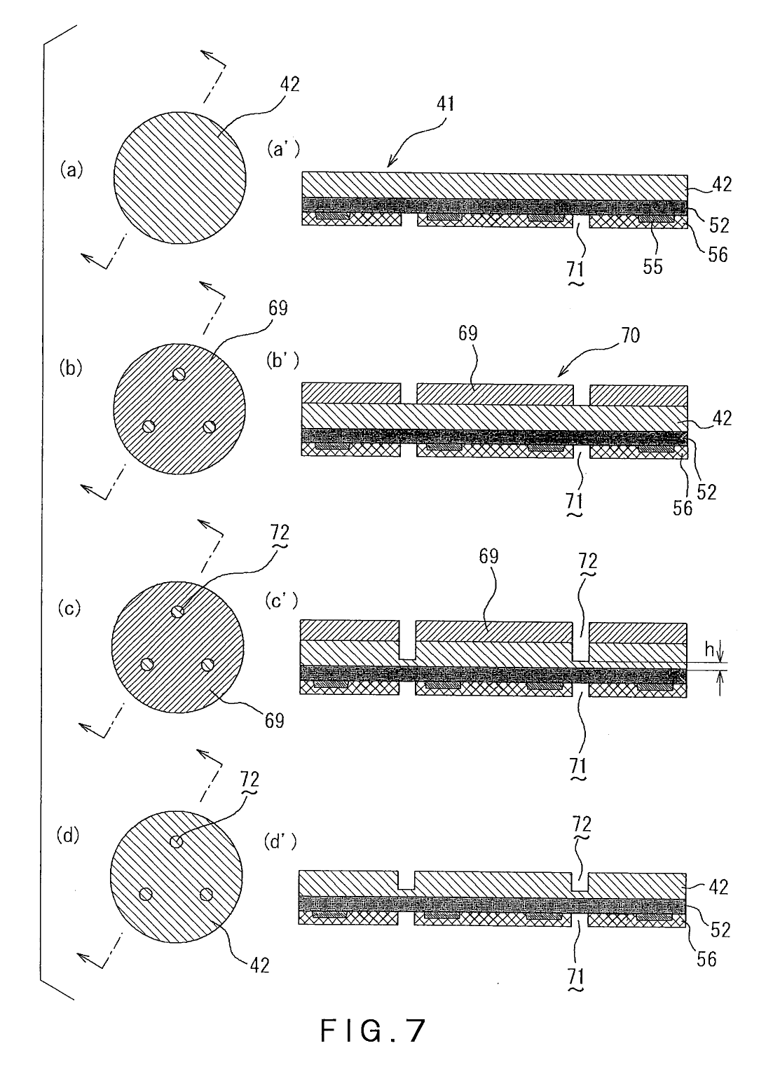

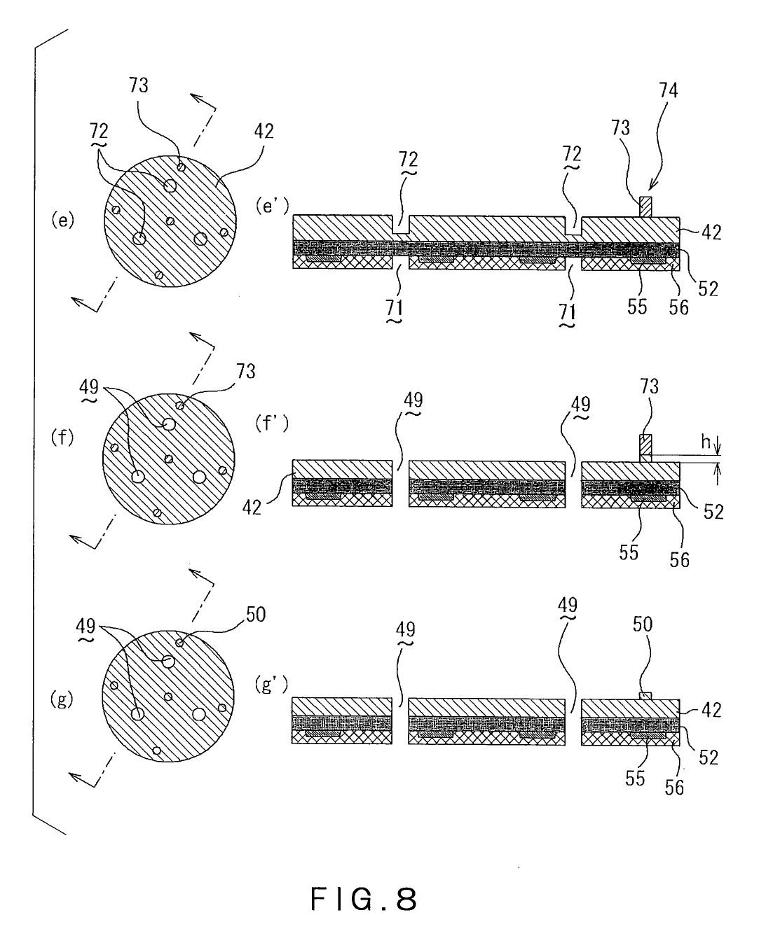

Au film 68 is then deposited on the whole surface of the polyimide film 64 by sputtering with the above-described resist pattern 67 left as it is (FIG. 6(h)). Thereafter, the resist pattern 67 is removed together with the Au film 68 formed on it (lift-off) (FIG. 6(i)). Thus, the Au film 68 remains only on the Pt film 61, and electrode terminals 48 having, on their surfaces, the Au film 68 are obtained.

[Procedure for Making Pin Insertion Holes 49 and Gap-Making Protrusions (FIGS. 7 and 8)]

The procedure for making the pin insertion holes 49 in the silicon base 42 and the gap pins 50 serving as gap-making protrusions on the front surface of the silicon base 42 is shown in FIGS. 7(a), 7(a′) to 7(d), 7(d′) and FIGS. 8(e), 8(e′) to 8(g), 8(g′). Views (a) to (d) on the left-hand side in FIG. 7 show the front surface of the hot plate 41, and views (a′) to (d′) on the right-hand side, the section of the hot plate 41 taken along the line crossing the pin insertion holes 49, indicated by the arrows. Views (e) to (g) on the left-hand side in FIG. 8 show the front surface of the hot plate 41, and views (e′) to (g′) on the right-hand side, the section of the hot plate 41 taken along the line crossing the pin insertion holes 49 and the gap pins 50, indicated by the arrows.

First, the silicon base 42 having the heater 43 and the temperature sensors 47 is placed with its front surface facing up (FIGS. 7(a), 7(a′)). A photoresist layer 69 is formed on the whole front surface of the silicon base 42, and a resist pattern 70 having openings, corresponding to a predetermined pin insertion hole pattern, is photolithographically formed via the steps of exposure, development, and photoresist stripping (FIGS. 7(b), 7(b′)). Openings 71 are also made beforehand in the back surface of the polyimide film 56 in the positions corresponding to those of the pin insertion holes.

Using the resist pattern 70 as a mask, the silicon base 42 is dry-etched from the front side so that it remains non-etched by a predetermined thickness (height h), thereby making cavities 72 (FIGS. 7(c), 7(c′)). Thereafter, the resist pattern 70 is removed (resist ashing) (FIGS. 7(d), 7(d′)).

Subsequently, a resist pattern 74 is formed on the surface of the silicon base 42 having the cavities 72 so that a photoresist 73 remains only in the positions corresponding to those of the gap pins (FIGS. 8(e), 8(e′)). Using this resist pattern 74 as a mask, the silicon base 42 is dry-etched from the front side so that it is removed by a predetermined thickness (height h), and, at the same time, those portions of the SiO₂ film 52 situated under the cavities 72 are also removed (FIGS. 8(f), 8(f′)). The cavities 72 are thus communicated with the openings 71 that have been made beforehand in the polyimide film 56 on the backside, whereby predetermined pin insertion holes 49 are formed in the silicon base 42. The resist pattern 74 is then removed (resist ashing) (FIGS. 8(g), 8(g′)). On the front surface of the silicon base 42 remain gap pins 50 with a predetermined height h.

### Second Embodiment

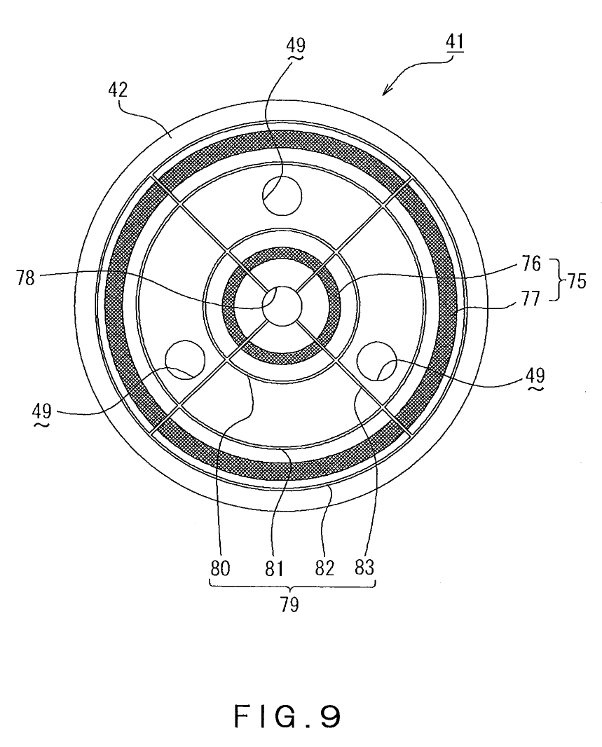

FIG. 9 is a view showing the front surface of a hot plate 41 according to the second embodiment of the present invention.

In the above-described first embodiment, the gap pins 50 are formed as gap-making protrusions by etching the silicon base 42. In this second embodiment, on the other hand, annular protrusions 75 uniform in thickness are made on the front surface of the silicon base 42 as the gap-making protrusions by the use of a polyimide resin, an insulating synthetic resin material, as shown in FIG. 9. In the case shown in FIG. 9, a first annular protrusion 76 is formed in the center of the silicon base 42, and a second annular protrusion 77, at the edge. These annular protrusions 75 are made in such positions that they do not cross the three pin insertion holes 49.

In the front surface of the silicon base 42, a vacuum holding hole 78 is made in the center, and vacuum holding grooves 79 are made so that they communicate with the vacuum holding hole 78, in order that the hot plate may vacuum hold a semiconductor wafer W to subject it to heat treatment. The vacuum holding grooves 79 are also made in such positions that they do not cross the three pin insertion holes 49. In the case shown in FIG. 9, the vacuum holding grooves 79 include a first annular groove 80, a second annular groove 81, and a third annular groove 82 that are made around the vacuum holding hole 78, and four straight-line communicating grooves 83, extending in the direction of radius, for communicating the first, second, and third annular grooves with one another. The first annular protrusion 76 is positioned between the vacuum holding hole 78 situated in the center and the first annular groove 80, and the second annular protrusion 77, between the second annular groove 81 and the third annular groove 82. Therefore, the first annular protrusion 76 and the second annular protrusion 77 that are made from a polyimide resin are individually divided into four sectors by the above-described four communicating grooves 83 extending in the direction of radius. The three pin insertion holes 49 are positioned between the first annular protrusion 76 and the second annular protrusion 77.

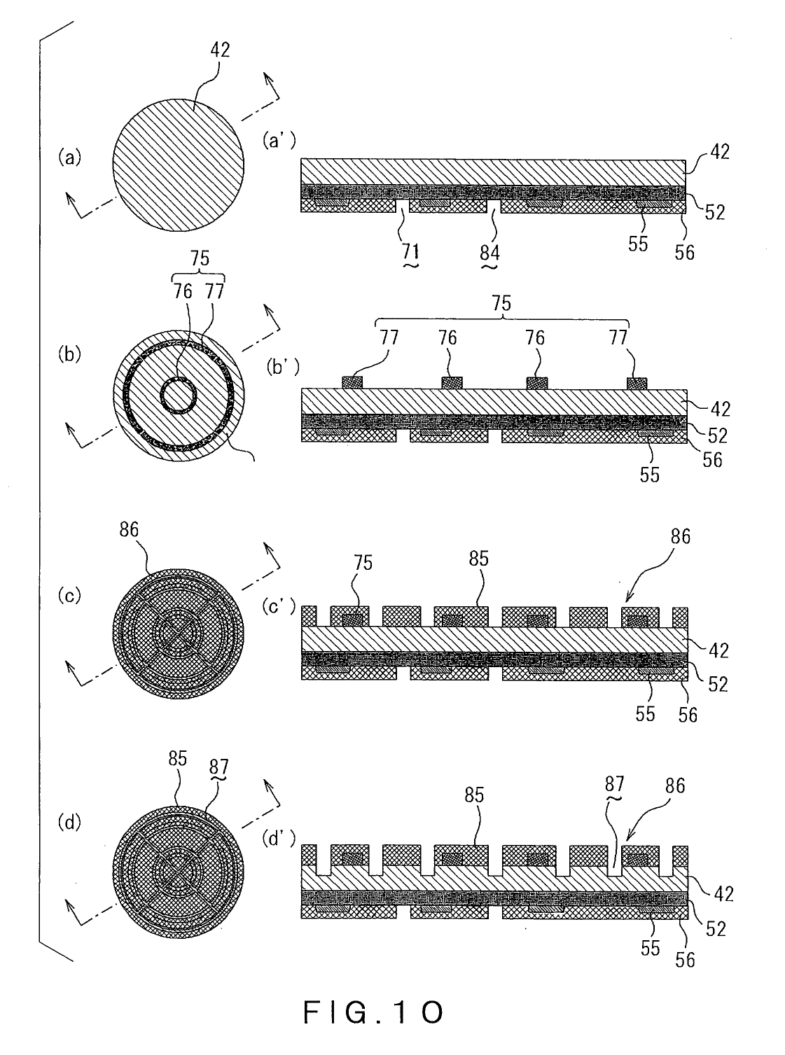

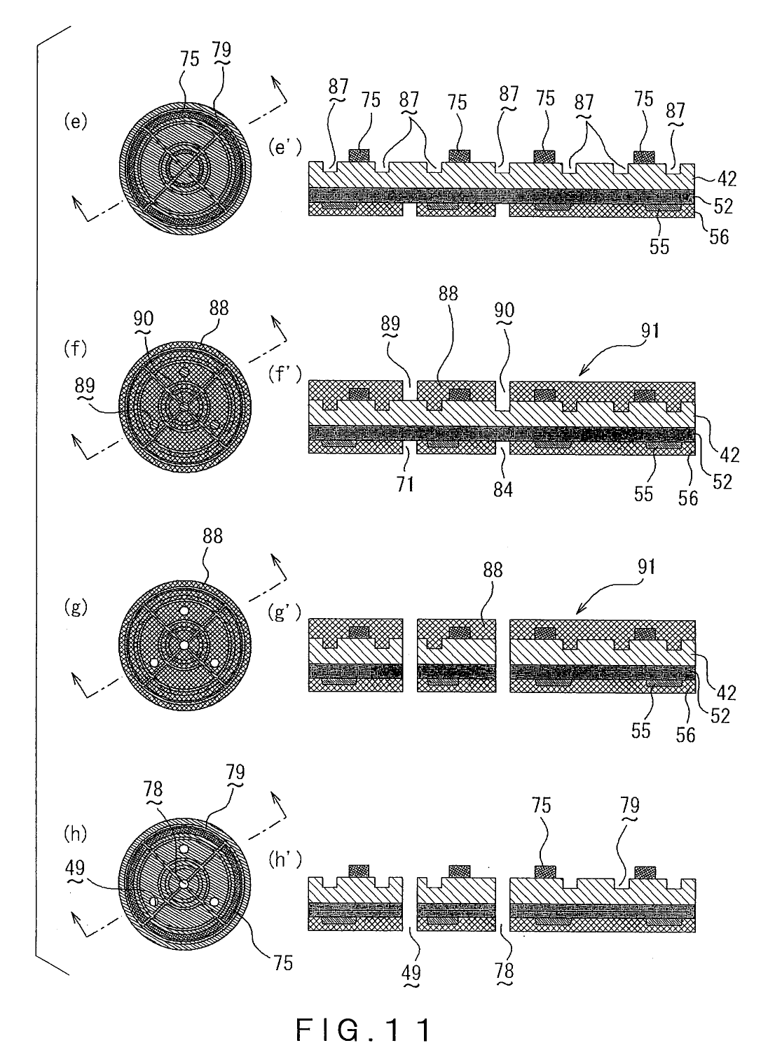

According to this second embodiment, since a gap can be precisely made between the hot plate and a semiconductor wafer W placed on it when the wafer W is vacuum-held and thermally treated, the vacuum holding force and the distribution of this force can be accurately controlled so that they become uniform within the wafer W plane.

[Procedure for Making Gap-Making Protrusions, Vacuum Holding Hole 78, Vacuum Holding Grooves 79, and Pin Insertion Holes 49 (FIGS. 10 and 11)]

The procedure for making the annular protrusions 75 serving as the gap-making protrusions, the vacuum holding grooves 79, and the vacuum holding hole 78 in the front surface of the silicon base 42 and the pin insertion holes 49 in the silicon base 42 will be described with reference to FIGS. 10(a), 10(a′) to 10(d), 10(d′) and FIGS. 11(e), 11(e′) to 11(h), 11(h′). In FIGS. 10 and 11, views (a)-(h) on the left-hand side show the front surface of the hot plate 41, and views (a′) to (h′) on the right-hand side, the section of the hot plate 41 taken along the line extending in the direction of radius, indicated by the arrows.

The silicon base 42 having the heater 43 and the temperature sensors 47 is first placed with its front surface facing up (FIGS. 10(a), 10(a′)). Openings 71 and an opening 84 are made beforehand in the polyimide film 56 on the backside at predetermined positions corresponding to the positions of the pin insertion holes and that of the vacuum holding hole, respectively. A first annular protrusion 76 and a second annular protrusion 77, polyimide-resin-made gap-making protrusions forming a predetermined protrusion pattern, are photolithographically formed on the front surface of the silicon base 42 (FIGS. 10(b), 10(b′)).

Thereafter, a photoresist layer 85 is formed on the whole front surface of the silicon base 42, and a resist pattern 86 corresponding to a predetermined vacuum holding groove 79 pattern is photolithographically formed via the steps of exposure, development, and photoresist stripping (FIGS. 10(c), 10(c′)).

Using the above resist pattern 86 as a mask, the silicon base 42 is dry-etched from the front side to form cavities 87 with a predetermined depth (FIGS. 10(d), 10(d′)). Thereafter, the resist pattern 86 is removed (FIGS. 11(e), 11(e′)). Predetermined vacuum holding grooves 79 are thus formed in the front surface of the silicon base 42 having the annular protrusions 75.

Subsequently, a resist pattern 91 having cavities 89 and a cavity 90, corresponding to a predetermined pin insertion holes—vacuum holding hole pattern, is photolithographically formed on the front surface of the silicon base 42 via the steps of photoresist 88 coating, exposure, development, and photoresist stripping (FIGS. 11(f), 11(f′)). The predetermined pin insertion holes—vacuum holding hole pattern is that the positions of the cavities 89 and the cavity 90 in the pattern agree with the positions of the openings 71 and the opening 84 that have been made in the polyimide film 56 in the back surface of the silicon base 42, respectively.

Using the above-described resist pattern 91 as a mask, the silicon base 42 is dry-etched from the front side, thereby communicating the cavities 89 and the cavity 90 with the openings 71 and the opening 84 on the backside of the silicon base 42, respectively (FIGS. 11(g), 11(g′)). The resist pattern 91 is then removed (resist ashing). Predetermined pin insertion holes 49 and predetermined vacuum holding hole 78 are thus obtained (FIGS. 11(h), 11(h′)).

### Third Embodiment

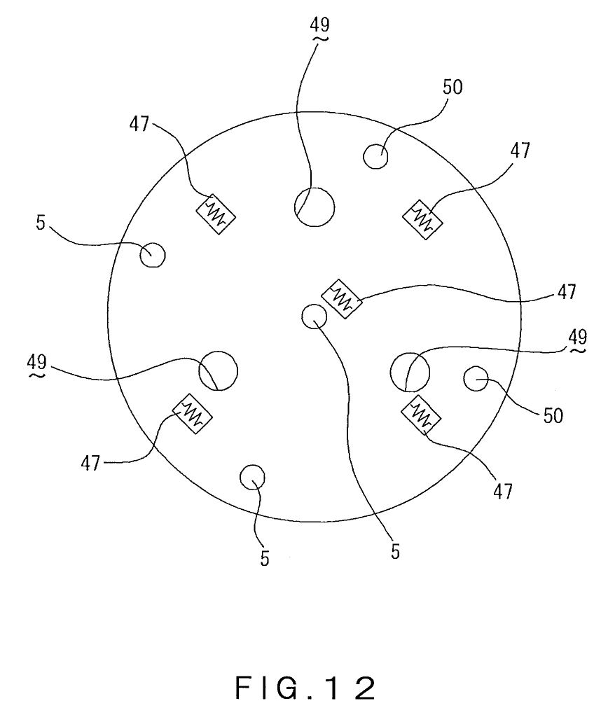

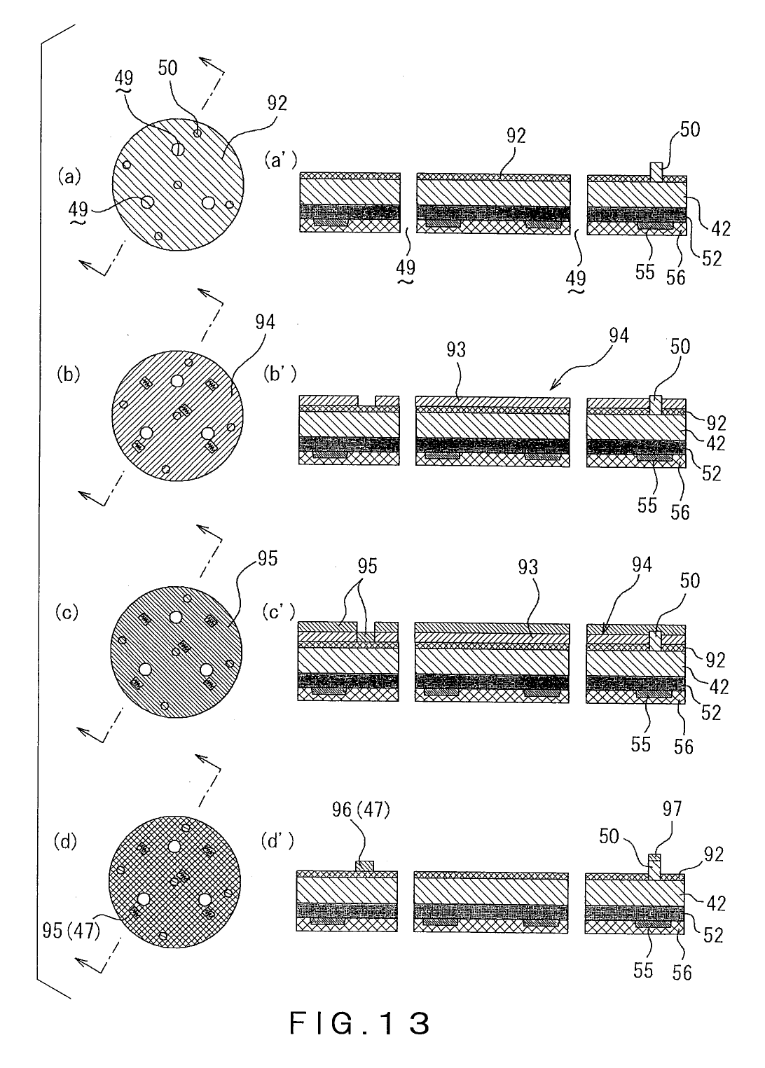

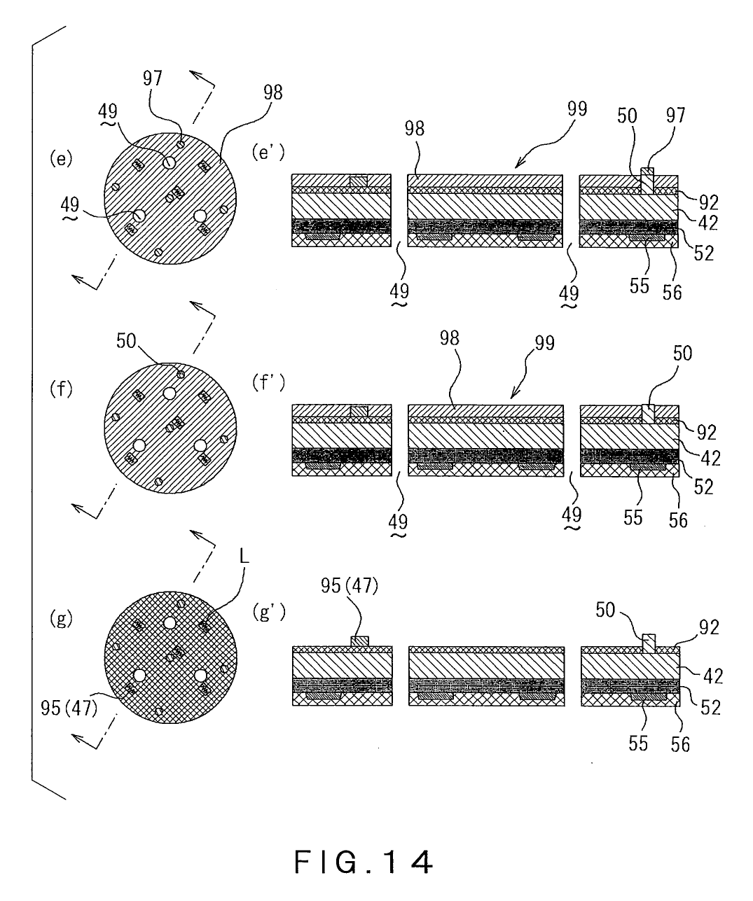

The third embodiment of the present invention is shown in FIG. 12. In this embodiment, temperature sensors 47 are formed not on the back surface but on the front surface of a silicon base 42. The third embodiment is advantageous in that since the temperature of a wafer W, an object of heating, can be controlled according to the temperature sensed at a point nearer the wafer W as compared with the case where temperature sensors 47 are formed on the back surface of a silicon base 42, the wafer W temperature can be controlled more accurately.

[Procedure for Making Temperature Sensors 47 on the Front Side (FIGS. 13 and 14)]

The procedure for making the temperature sensors 47 on the front surface of the silicon base 42 will be described. This procedure is shown in FIGS. 13 and 14. In FIGS. 13 and 14, views (a) to (g) on the left-hand side show the front surface of the hot plate 41, and views (a′) to (g′) on the right-hand side, a section of the hot plate 41 taken along the line crossing the gap pin 50, the pin insertion holes 49, and the temperature sensor 47, indicated by the arrows.

First, gap-pins 50 serving as the gap-making protrusions are formed on the front surface of the silicon base 42, and a polyimide film 92, an insulating polyimide-resin film, is formed on the whole front surface, excluding the gap pin 50 portions, of the silicon base 42 having the pin insertion holes 49.

Next, a resist pattern 94 corresponding to a predetermined sensor pattern is photolithographically formed on the polyimide film 92 via the steps of photoresist 93 coating, exposure, development, and photoresist stripping (FIGS. 13(b), 13(b′)).

Pt film 95 is then deposited on the whole surface of the polyimide film 92 by sputtering, with the resist pattern 94 left as it is (FIGS. 13(c), 13(c′)). Thereafter, the resist pattern 94 is removed together with the Pt film formed on it (lift-off) (FIGS. 13(d), 13(d′)). The Pt film 95 thus remains as Pt film 96, a resistor (temperature sensor 47), only in the belt-like area of the predetermined sensor pattern (precisely, the area that the linear resistor is zigzagged to form a belt-like plane as a whole). The level of the gap pin 50 top is higher than that of the polyimide film 92 surface and that of the photoresist 93 surface, so that the Pt film 95 remains as unnecessary Pt film 97 on top of the gap pins 50 even after the resist pattern 94 has been removed.

In order to remove this unnecessary Pt film 97, a photoresist 98 is applied to the polyimide film 92 on the front surface of the silicon base 42 excluding the Pt film 97 portions, (FIGS. 14(e), 14(e′)), and by using this resist pattern 99 as a mask, the silicon base 42 is dry-etched to remove the Pt film 97 (FIGS. 14(f), 14(f′)). The resist pattern 99 is then removed (resist ashing) (FIGS. 14(g), 14(g′)). Temperature sensors 47 are thus formed on the front surface of the silicon base 42 having the gap pins 50.

In the aforementioned embodiments, the heater 43 is made first, but the order in which the heater 43, the temperature sensors 47, and the gap-making protrusions are made may be changed accordingly.

Application of the hot plate 41 according to the present invention to heat treatment equipment in a resist coating/development system for treating a semiconductor wafer will be described hereinafter.

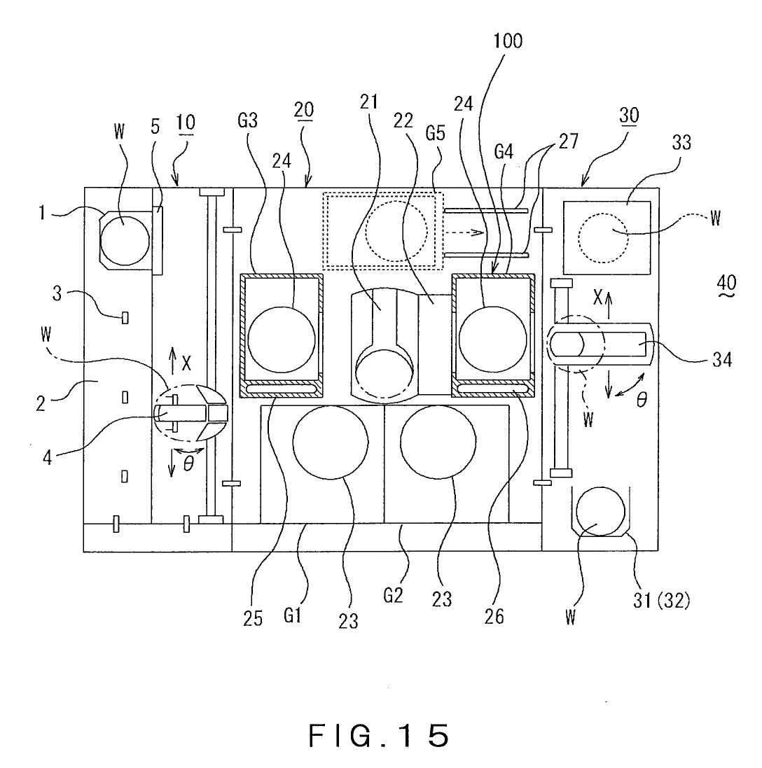

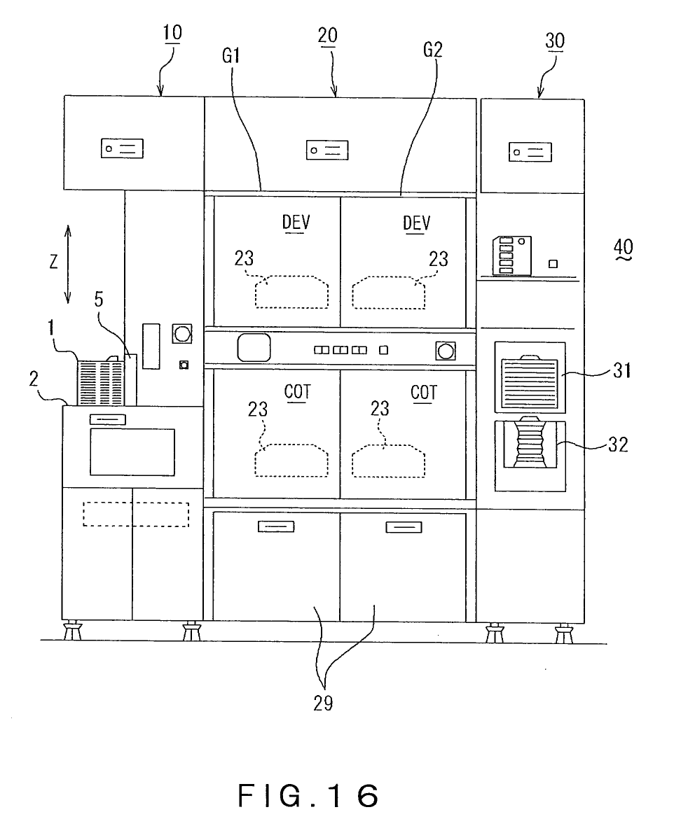

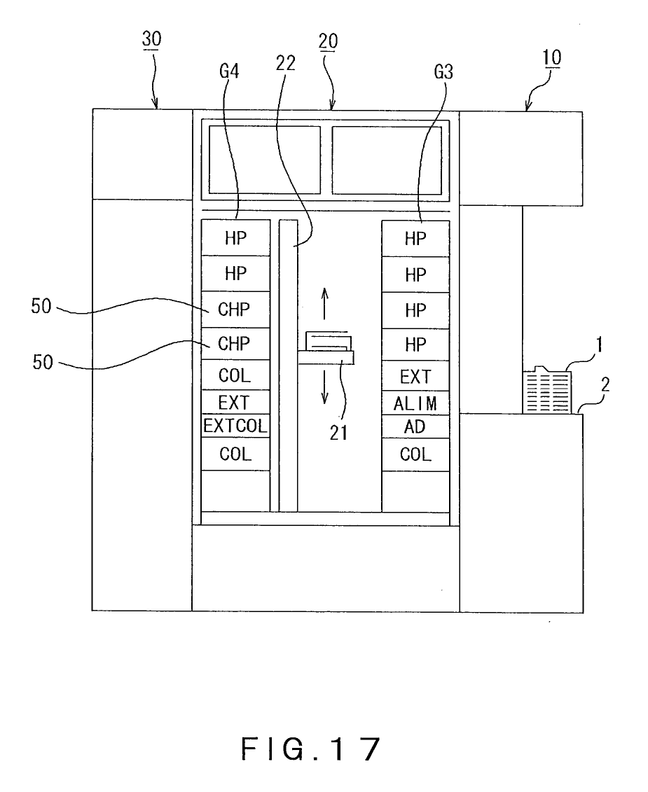

FIG. 15 is a diagrammatical plane view showing an embodiment of the above-described resist coating/development system. FIG. 16 is a plane view of the system shown in FIG. 15, and FIG. 17, a rear view of the system shown in FIG. 15.

The main part of the resist coating/development system is composed of a cassette station 10 (carrier part) for carrying a plurality of semiconductor wafers W (hereinafter referred to simply as a wafer W), substrates to be treated, e.g., 25 wafers, placed in a cassette 1, into the system from the outside or carrying this cassette 1 out of the system, or carrying wafers W in or out of the wafer cassette 1; a treatment station 20 having a treatment system in which various single substrate treatment units for treating, as predetermined, wafers W one by one in the resist coating/development step are arranged multistory-wise in predetermined positions; and an interface part 30 for delivering the wafers W to an exposure system (not shown in the figure) positioned next to the treatment station 20.

As shown in FIG. 15, the cassette station 10 has the following structure: a plurality of wafer cassettes 1, e.g., at most four, are put on protrusions 3, protruding from a cassette table 2, in a raw in the X direction, the horizontal direction, with the openings of the cassettes through which wafers are carried in or out facing the treatment station 20 side, and a wafer-carrying pincette 4, movable in the direction in which the cassettes are arranged (the X direction) and also in the direction in which wafers W are vertically piled in the cassette 1 (the Z direction), selectively carries wafers W to the cassettes 1. Further, the wafer-carrying pincette 4 is rotatable in the θ direction, so that it can also carry wafers to an alignment unit (ALIM) and an extension unit (EXT), which will be described later, belonging to the multistage unit of the third group G3 in the treatment station 20.

As shown in FIG. 15, the treatment station 20 has, in the center, a main wafer-transfer mechanism 21 of vertical transfer type that moves vertically owing to a transfer mechanism 22, and all treatment units, grouped into one, or two or more, are arranged multistory-wise around this main wafer-transfer mechanism 21. In the case shown in FIG. 15, treatment units of five groups G1, G2, G3, G4, and G5 are in a multistory arrangement, where the multistage units of the first and second groups G1 and G2 are placed side by side on the front, the multistage unit of the third group G3, next to the cassette station 10, the multistage unit of the fourth group G4, next to the interface unit 30, and the multistage unit of the fifth group G5, on the rear.

In this case, in the first group G1, a development unit (DEV) in which a resist pattern is developed with a wafer W facing a developer supply means (not shown in the figure) is placed on a resist-coating unit (COT) in which a wafer W held by a spin chuck (not shown in the figure) is treated in a cup 23, a vessel, as predetermined, as shown in FIG. 16. The second group G2 is the same as the first group G1, i.e., a development unit (DEV) is on a resist-coating unit (COT). The reason why the resist-coating unit (COT) is placed on the lower row is that the discharge of a resist liquid is troublesome from the viewpoint of mechanism and maintenance. However, the resist-coating unit (COT) may be placed on the upper row, if necessary.

As shown in FIG. 17, in the third group G3, oven-type treatment units in which a wafer W is placed on a wafer table 24 (see FIG. 15) and is treated as predetermined, such as a cooling unit (COL) for cooling a wafer W, an adhesion unit (AD) for making a wafer W hydrophobic, an alignment unit (ALIM) for positioning a wafer W, an extension unit (EXT) for carrying a wafer in or out, and four hot plate units (HP) for baking a wafer W, are successively stacked vertically 8 high in the order mentioned, the cooling unit being on the lowest row.

In the fourth group G4, oven-type treatment units, such as a cooling unit (COL), an extension cooling unit (EXTCOL), an extension unit (EXT), a cooling unit (COL), two chilling hot plate units (CHP) having the function of rapidly cooling a wafer, and two hot plate units (HP), are successively stacked vertically 8 high in the order mentioned, the cooling unit being on the lowest row. The chilling hot plate unit (CHP) and the hot plate unit (HP) use heat treatment equipment using a hot plate 41 according to the present invention.

By placing the cooling unit (COL) and the extension cooling unit (EXTCOL), in which a wafer is treated at a low temperature, on the lower row, and the hot plate unit (HP), the chilling hot plate unit (CHP), and the adhesion unit (AD), in which a wafer is treated at a high temperature, on the upper row, it is possible to decrease the thermal interference between the units. These units may, of course, be placed at random.

In the treatment station 20, the multistage units (oven-type treatment units) of the third and fourth groups G3 and G4, positioned next to the multistage units (spinner-type treatment units) of the first and second groups G1 and G2, have ducts 25, 26, respectively, made vertically in the longitudinal direction in their side walls, as shown in FIG. 15. In these ducts 25, 26, clean air or air at a specially controlled temperature is allowed to flow as down flow. The ducts prevent the heat produced in the oven-type treatment units of the third and fourth groups G3 and G4 from transferring to the spinner-type treatment units of the first and second groups G1 and G2.

Further, in this treatment unit, a multistage unit of the fifth group G5 may be placed on the rear of the main wafer-transfer mechanism 21, as indicated by the dotted lines in FIG. 15. The multistage unit of the fifth group G5 is movable along a guide rail 27 toward the side of the main wafer-transfer mechanism 21. Therefore, even if the multistage unit of the fifth group G5 is present, a space can be secured by sliding the unit, so that it is easy to conduct maintenance operations for the main wafer-transfer mechanism 21 from the rear.

The above-described interface part 30 has the same depth as the treatment station 20 but a smaller width than the treatment station 20. On the front of this interface part 30, a fixed buffer cassette 32 is placed on a transferable pick-up cassette 31, and, on the rear, an edge exposure system 33 that is an exposure means of exposing the edge and the identification mark area of a wafer to light is placed. A carrier arm 34, a carrying means, is placed in the center of the interface part 30. This carrier arm 34 can move in the X and Z directions to carry a wafer W to the cassettes 31, 32 and to the edge exposure system 33. Further, the carrier arm 34 can rotate in the θ direction to carry a wafer W also to the extension unit (EXT) belonging to the multistage unit of the fourth group G4 in the treatment station 20, and to a wafer-delivering table (not shown in the figure) in the exposure system, positioned next to the EXT.

The treatment system having the above-described structure is installed in a clean room 40, and also inside the system, the cleanness of each part of the system is increased by a highly efficient method using a vertical laminar flow.

Next, the heat treatment equipment using a hot plate of the present invention, constituting the above-described hot plate unit (HP) or chilling hot plate unit (CHP), will be described in detail with reference to FIG. 15. The use of the heat treatment equipment using a hot plate according to the present invention in the chilling hot plate unit (CHP) will now be described.

As shown in FIG. 18, the heat treatment equipment 100 comprises, in the casing (not shown in the figure) of the heat treatment unit, a heating part 100a for heating a wafer W and a cooling part 100b for cooling a wafer W. The heating part 100a comprises a hot plate 41 on which a wafer W having, on its surface, a resist film, a coating film, is placed for heat treatment, a support 101 for supporting the hot plate 41, surrounding the lower part of the outer edge of the hot plate 41, a support ring 102 surrounding the lower part of the periphery of the support 101, and a cover 104 for covering the upper opening of the support ring 102 to form a heat treatment chamber 103 along with the supporting ring 102. An annular, concave groove 105 is made in the upper surface of the support ring 102 with which the cover 104 is brought into contact, and an O-ring 106 is fit into this groove 105.

A heater 43 whose output is controlled by a temperature controller 107 to be set to a predetermined temperature is formed on the back surface of the hot plate 41 by the method for making the heater described in the aforementioned first embodiment. Further, three pin insertion holes 49, through holes, are made in the hot plate 41 at three points on concentric circles so that they are positioned at the three apexes of a triangle. Three support pints 109 that go up and down with an elevation drive mechanism 108 positioned under the hot plate 41 can pass through the pin insertion holes 49, so that with this movement of the support pins 109, a wafer W is delivered to a cooling plate 110 in the cooling part 100b.

Temperature sensors 47, a means of sensing the temperature of the hot plate 41, are formed on the front surface of the hot plate 41 by the above-described method of making the temperature sensors. The signal of the hot plate 41 temperature, sent from the temperature sensors 47, is transmitted to a controller 112, a controlling means composed mainly of a central treatment unit (CPU) of a control computer 111. The temperature of the hot plate 41 is kept constant by the temperature controller 107 that is under control of the controller 112.

A supporting part 113 is formed so that it projects from one side of the above-described cover 104, and a piston rod 115 in the cover-elevation mechanism, e.g., an elevation cylinder 114, is connected to this supporting part 113. Therefore, by driving the elevation cylinder 114, the cover 104 is brought into contact with or detached from the support ring 102, i.e., the cover 104 is moved to open or close the opening of the support ring 102.

The elevation cylinder 114 and the elevation drive mechanism 108 are electrically connected to the controller 112, and the control signals sent from the controller 112 drive them, i.e., the cover 104 is moved to open or close the opening of the support ring 102, and the support pins 109 go up and down.

Next, the operation of the resist coating/development system will be described. In the cassette station 10, the wafer-carrying pincette 4 accesses to a cassette 1 containing untreated wafers W, placed on the cassette table 2, and takes one wafer W out of the cassette 1. After taking a wafer W out of the cassette 1, the wafer-carrying pincette 4 moves to the alignment unit (ALIM) in the multistage unit of the third group G3 in the treatment station 20 and puts the wafer W on the wafer table 24 in the unit (ALIM). The wafer W on the wafer table 24 is subjected to orientation flat alignment and centering. Thereafter, the main wafer-transfer mechanism 21 accesses to the alignment unit (ALIM) from the opposite direction and receives the wafer W from the wafer table 24.

In the treatment station 20, the main wafer-transfer mechanism 21 first carries the wafer W into the adhesion unit (AD) belonging to the multistage unit of the third group G3. In this adhesion unit (AD), the wafer W is treated to be hydrophobic. After this treatment, the main wafer-transfer mechanism 21 takes the wafer out of the adhesion unit (AD) and carries it into the cooling unit (COL) belonging to the multistage unit of the third or fourth group G3 or G4. In this cooling unit (COL), the wafer W is cooled to a temperature, e.g., 23° C., that has been set as a pre-resist coating temperature. After this cooling treatment, the main wafer-transfer mechanism 21 takes the wafer out of the cooling unit (COL) and carries it into the resist coating unit (COT) belonging to the multistage unit of the first or second group G1 or G2. In this resist coating unit (COT), the wafer W surface is spin-coated with a resist so that it is covered with a resist film uniform in thickness.

After the step of resist coating, the main wafer-transfer mechanism 21 takes the wafer W out of the resist coating unit (COT) and carries it into the hot plate unit (HP). In the hot plate unit (HP), the wafer is placed on the table and pre-baked at a predetermined temperature, e.g., 100° C., for a predetermined period of time. With this pre-baking, the solvent remaining in the resist film on the wafer W can be removed by evaporation. After the step of pre-baking, the main wafer-transfer mechanism 21 takes the wafer W out of the hot plate unit (HP) and carries it into the extension cooling unit (EXTCOL) belonging to the multistage unit of the fourth group G4. In this unit (EXTCOL), the wafer W is cooled to a temperature, e.g., 24° C., fit to the next step, which is edge exposure treatment to be carried out in the edge exposure system 33. After the wafer W has been cooled, the main wafer-transfer mechanism 21 carries the wafer W to the extension unit (EXT) positioned right above the EXTCOL and puts it on a table (not shown in the figure) in this unit (EXT). As soon as the wafer W is placed on the table in this extension unit (EXT), the carrier arm 34 in the interface part 30 accesses to the table from the opposite direction and receives the wafer W. The carrier arm 34 carries the wafer W into the edge exposure system 33 in the interface part 30.

After the whole surface of the wafer W has been exposed to light in the exposure system and the wafer W has been returned to a wafer-receiving table in the exposure system, the carrier arm 34 in the interface part 30 accesses to the wafer-receiving table to receive the wafer W and carriers it into the extension unit (EXT) belonging to the multistage unit of the fourth group G4 in the treatment station 20 and places it on a wafer-receiving table. In this step, the wafer W may be temporarily contained in the buffer cassette 32 in the interface part 30 before it is delivered to the multistage unit in the treatment station 20.

The wafer W placed on the wafer-receiving table is carried by the main wafer-transfer mechanism 21 into the chilling hot plate unit (CHP) and is subjected to post exposure baking in order to prevent occurrence of fringes, or to induce acid catalyst reaction in a chemically amplified resist (CAR).

Thereafter, the wafer W is carried into the development unit (DEV) belonging to the multistage unit of the first or second group G1 or G2. In this development unit (DEV), a developer is evenly spread over the resist film on the wafer W surface for development.

After the development step, the main wafer-transfer mechanism 21 takes the wafer W out of the development unit (DEV) and carries it into the hot plate unit (HP) belonging to the multistage unit of the third or fourth group G3 or G4. In this unit (HP), the wafer W is post-baked at a temperature of e.g., 100° C., for a predetermined period of time. By this treatment, the resist swollen in the development hardens to have improved chemical resistance.

After the step of post-baking, the main wafer-transfer mechanism 21 takes the wafer W out of the hot plate unit (HP) and carries it into one of the cooling units (COL). After the wafer W has been cooled to normal temperatures in this unit, the main wafer-transfer mechanism 21 carries the wafer W to the extension unit (EXT) belonging to the multistage unit of the third group G3. As soon as the wafer W is placed on a table (not shown in the figure) in this extension unit (EXT), the wafer-carrying pincette 44 in the cassette station 10 accesses to the table from the opposite direction and receives the wafer W. The wafer-carrying pincette 4 puts the wafer W in a predetermined wafer-containing groove for containing a treated wafer, in the cassette 1 placed on the cassette table 2. Thus, the treatment of the wafer W is completed.

1. A hot plate for heating a substrate placed on the hot plate, comprising:
a silicon base having pin insertion holes through which support pins for supporting a substrate from below and elevating the substrate above the hot plate pass,
a heater composed of a resistor made of a metal film deposited on the back surface of the silicon base,
a temperature sensor composed of a resistor made of a metal film deposited on the back or front surface of the silicon base, and p1 gap-making protrusions for making a gap between the hot plate and the substrate placed on the gap-making protrusions, made on the front surface of the silicon base.

2. The hot plate according to claim 1, wherein the heater is made of platinum (Pt) film and the temperature sensor is also made of platinum (Pt) film.

3. The hot plate according to claim 2, wherein the gap-making protrusions are gap pins made of silicon, formed on the front surface of the silicon base.

4. The hot plate according to claim 2, wherein the gap-making protrusions are protrusions made of a synthetic resin material, formed on the front surface of the silicon base.

5. The hot plate according to claim 2, wherein the front surface of the silicon base has a vacuum holding groove and a vacuum holding hole that are useful for vacuum holding a substrate for subjecting the substrate to heat treatment.

6. The hot plate according to claim 1, wherein the gap-making protrusions are gap pins made of silicon, formed on the front surface of the silicon base.

7. The hot plate according to claim 6, wherein the front surface of the silicon base has a vacuum holding groove and a vacuum holding hole that are useful for vacuum holding a substrate for subjecting the substrate to heat treatment.

8. The hot plate according to claim 1, wherein the gap-making protrusions are protrusions made of a synthetic resin material, formed on the front surface of the silicon base.

9. The hot plate according to claim 8, wherein the front surface of the silicon base has a vacuum holding groove and a vacuum holding hole that are useful for vacuum holding a substrate for subjecting the substrate to heat treatment.

10. The hot plate according to claim 1, wherein the front surface of the silicon base has a vacuum holding groove and a vacuum holding hole that are useful for vacuum holding a substrate for subjecting the substrate to heat treatment.

11. A process for producing a hot plate for heating a substrate placed on the hot plate, comprising the steps of:
making a heater composed of a resistor by depositing a metal film on the back surface of a silicon base by sputtering,
making a temperature sensor composed of resistors by depositing a metal film on the back or front surface of the silicon base by sputtering,
making, in the silicon base, pin insertion holes through which support pins for supporting a substrate from below and elevating the substrate above the hot plate pass, and
making, on the front surface of the silicon base, gap-making protrusions for making a gap between the hot plate and the substrate placed on the gap-making protrusions.

12. The process for producing a hot plate according to claim 11, wherein platinum (Pt) is used as a material for the heater and for the temperature sensor.

13. The process for producing a hot plate according to claim 12, wherein gap pins made of silicon are formed as the gap-making protrusions by etching the front surface of the silicon base.

14. The process for producing a hot plate according to claim 12, wherein protrusions made of a synthetic resin material are made as the gap-making protrusions on the front surface of the silicon base by using a synthetic resin material.

15. The process for producing a hot plate according to claim 12, further comprising the step of making, in the front surface of the silicon base by a photolithographic technique and etching, a vacuum holding groove and a vacuum holding hole that are useful for vacuum holding a substrate for subjecting the substrate to heat treatment.

16. The process for producing a hot plate according to claim 11, wherein gap pins made of silicon are formed as the gap-making protrusions by etching the front surface of the silicon base.

17. The process for producing a hot plate according to claim 16, further comprising the step of making, in the front surface of the silicon base by a photolithographic technique and etching, a vacuum holding groove and a vacuum holding hole that are useful for vacuum holding a substrate for subjecting the substrate to heat treatment.

18. The process for producing a hot plate according to claim 11, wherein protrusions made of a synthetic resin material are made as the gap-making protrusions on the front surface of the silicon base by using a synthetic resin material.

19. The process for producing a hot plate according to claim 18, further comprising the step of making, in the front surface of the silicon base by a photolithographic technique and etching, a vacuum holding groove and a vacuum holding hole that are useful for vacuum holding a substrate for subjecting the substrate to heat treatment.

20. The process for producing a hot plate according to claim 11, further comprising the step of making, in the front surface of the silicon base by a photolithographic technique and etching, a vacuum holding groove and a vacuum holding hole that are useful for vacuum holding a substrate for subjecting the substrate to heat treatment.
